(19) United States
(12) Patent Application Publication
(10) Pub. No.: US 2011/0125563 A1
(43) Pub. Date: May 26, 2011

(54) Systems and Methods for Reducing Environmental Impact Using Filtered Water Alternatives

(76) Inventors: Elizabeth Haynes Klein, Cincinnati, OH (US); Deborah Ann Vargo, Wyoming, OH (US); Mark Alan Chawner, Cincinnati, OH (US)

(21) Appl. No.: 12/941,333

(22) Filed: Nov. 8, 2010

Related U.S. Application Data
(60) Provisional application No. 61/258,677, filed on Nov. 6, 2009.

(51) Int. Cl. G06Q 10/00; G06Q 90/00; G06Q 30/00

(52) U.S. Cl. 705/14.16; 705/500; 705/1.1; 705/27.1

(57) ABSTRACT

A method of reducing environmental impact by providing filtered water alternatives at various locations within grounds of an institution is provided. The method includes providing a branded filtered water system to an institution. The branded filtered water system including a plurality of portable, reusable water containers and a network of point-of-use water filtration devices to be placed at various locations within the institution. The point-of-use water filtration devices are interrelated by branding the point-of-use water filtration devices to provide a visual association with the filtered water system.

### CROSS REFERENCE TO RELATED APPLICATIONS

Pursuant to 35 U.S.C. §119(e), this application claims the benefit of the filing date of U.S. Provisional Application Ser. No. 61/258,677 filed Nov. 6, 2009, the entire disclosure of which is hereby incorporated by reference.

### FIELD OF THE INVENTION

The present invention is generally directed to systems and methods for reducing environmental impact using filtered water alternatives.

### BACKGROUND

Consumer interest in drinking water continues to rise. Sales of bottled water and water treatment devices, such as pitchers/carafes used to filter water are significant. For example, bottled water sales in the United States surpassed 8 billion gallons in 2006. Suppliers of drinking water and water treatment devices work diligently to try to set their products apart from others in the industry.

The environmental impact of bottled water is becoming an increasing concern to many. According to the Container Recycling Institute, the amount of polyethylene terephthalate (PET) bottles going into landfills increased from about 1,175 million pounds to about 3,900 million pounds between 1995 and 2005. A significant percentage of the PET bottles going into landfills and being incinerated are water bottles. A significant amount of resources may be utilized in producing, disposing and transporting large numbers of water bottles to retail stores where they are put on display for consumer purchase.

Many consumers are interested in alternatives to bottled drinking water, particularly “single serve” sizes of less than one liter. Such single serve sized bottles are commonly littered and have a lower recycling frequency compared to many other common packaging materials. Water filtering devices are available to consumers, such as home water filtration systems, that can be used to filter relatively large amounts of tap water. Many consumers have recognized that there may be benefits in filtering water at home, such as cost reduction benefits, increased convenience and a reduction in environmental concerns compared to buying bottled water. However, the capability of filtering water outside one's home may be limited. Accordingly, there is a need for systems and methods for reducing environmental impact using filtered water alternatives.

### SUMMARY

In one embodiment, a method of reducing environmental impact by providing filtered water alternatives at various locations within grounds of an institution includes providing a branded filtered water system to members of an institution. The branded filtered water system includes a plurality of portable, reusable water containers and a network of point-of-use water filtration devices to be placed at various locations within grounds of the institution. The method further includes interrelating the point-of-use water filtration devices by branding the point-of-use water filtration devices to provide a visual association with the filtered water system.

In another embodiment, a method of reducing environmental impact by providing a branded filtered water system to members of an institution includes providing an e-commerce website where members of an institution purchase components of a branded filtered water system and appointing members of the institution to be facilitators who direct members of the institution to the e-commerce website to purchase components of the branded filtered water system. The method further includes selling one or more components of the branded filtered water system to the members of the institution through the e-commerce website and arranging for the one or more components of the branded filtered water system to be transported to the member of the institution who purchased the component through the e-commerce website.

In another embodiment, a method of reducing plastic bottle waste by providing filtered water at various locations within an institution includes providing a branded filtered water system to members of an institution, the branded filtered water system including a plurality of point-of-use water filtration devices to be placed at various locations within the institution, wherein the point-of-use water filtration devices each include a source indicator identifying membership to the branded filtered water system. The method further includes providing a metering system configured to track an amount of filtered water dispensed by at least one of the point-of-use water filtration devices, and determining plastic bottle savings using information from the metering system.

### BRIEF DESCRIPTION OF THE DRAWINGS

The following detailed description of specific embodiments of the present invention can be best understood when read in conjunction with the drawings enclosed herewith.

FIG. 1 is a plan view of an embodiment of an institution including a filtered water distribution system;

FIG. 2 illustrates various embodiments of point-of-use water filtration devices and an embodiment of a portable, reusable container for use in the filtered water distribution system of FIG. 1;

FIG. 3 is a diagrammatic view of a kiosk-type point-of-use water filtration system for use in the filtered water distribution system of FIG. 1;

FIG. 4 is an exploded view of an embodiment of a pitcher-type point-of-use water filtration system for use in the filtered water distribution system of FIG. 1;

FIG. 5 illustrates an embodiment of a cartridge assembly for use in the point-of-use water filtration system of FIG. 4;

FIG. 6 is a side, perspective view of a faucet-mounted point-of-use water filtration system for use in the filtered water distribution system of FIG. 1;

FIG. 7 is a side, section view of the point-of-use water filtration system of FIG. 6;

FIG. 8 illustrates an embodiment of a metering system for use with the point-of-use water filtration system of FIG. 6;

FIG. 9 illustrates an embodiment of a sterilization device;

FIG. 10 illustrates an embodiment of an access control system for controlling access to the point-of-use water filtration devices;

FIG. 11 illustrates an embodiment of an access key for use in the access control system of FIG. 10;

FIG. 12 illustrates another embodiment of an access key for use in the access control system of FIG. 10;

FIG. 13 illustrates another embodiment of an access key for use in the access control system of FIG. 10;

FIG. 14 illustrates yet another embodiment of an access key for use in the access control system of FIG. 10;

FIG. 15 illustrates an embodiment of a system and method of collecting and processing dispensing information;

FIG. 16 illustrates an embodiment of a method of reducing environmental impact by providing a filtered water alternative at various locations on grounds of an institution; and

FIG. 17 illustrates an embodiment of a method of reducing environmental impact by providing a filtered water alternative to members of an institution.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

It should also be understood that, unless a term is expressly defined in this specification using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

As used herein, the term “institution” refers to any organization or business.

As used herein, the term “grounds” refers to a tract of land, including any structures disposed on the land such as, for example, buildings, houses, kiosks, portable trailers, etc. appropriated for use by an institution.

As used herein, the term “point-of-use water filtration device” refers to water filtration devices that are installed and/or located where the filtered water is to be accessed and filter the water at that point. Point of use water filters include kiosks, faucet mount, pitchers, etc.

As used herein, the term “water container” refers to any container suitable for holding water.

As used herein, the term “portable” refers to the capability of being carried or transported by hand. One example of a portable container is a container having a volume of about one liter or less.

As used herein, the term “reusable” in the context of a water container refers to the capability of being used repeatedly (i.e., refilled). In some embodiments, the term “reusable” in the context of a water container may refer to the capability of being refilled repeatedly without leaching of compounds from the container into the water.

As used herein, the terms “brand” and “branded” refer to a visual characteristic such as a mark, logo, label, or combinations thereof identifying a source.

I. System Overview

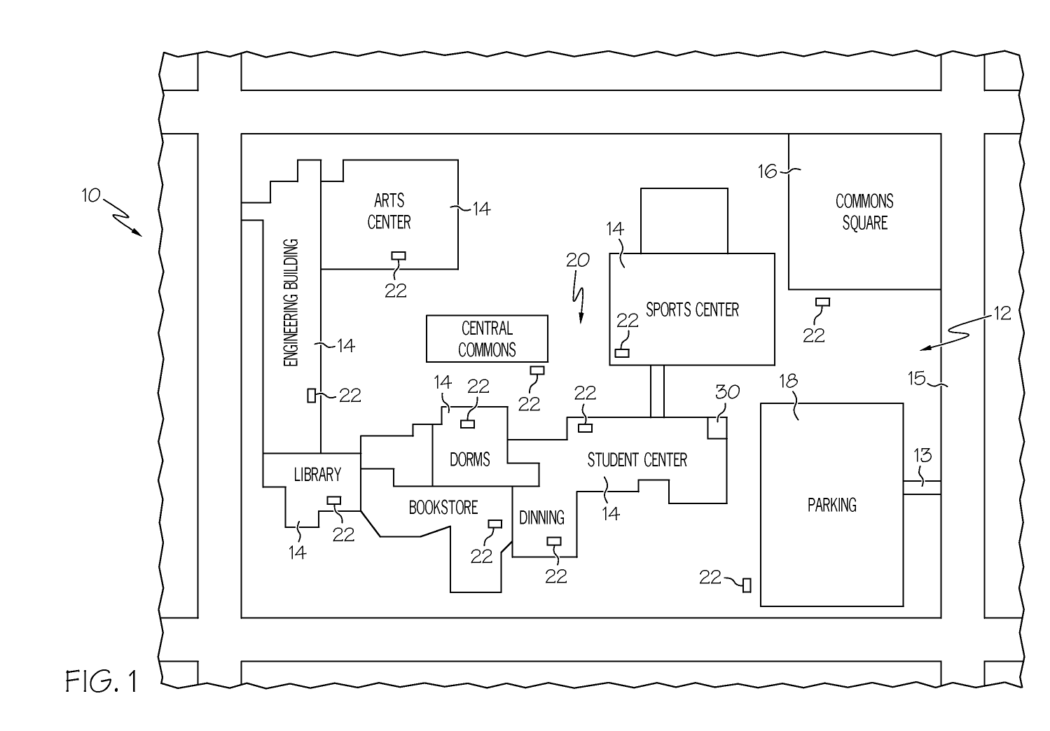

Referring to FIG. 1, a partial view of one exemplary embodiment of an institution 10 is illustrated. The institution 10 may be a college or university that includes grounds 12 where the institution 10 is physically located with buildings 14 at various locations throughout the grounds 12. In addition to buildings 14, the institution 10 may include other structures or areas, such as walkways 13, streets 15, commons 16, parking 18, amphitheaters, sports facilities such as stadiums, practice fields, etc. As will be described in greater detail below, a filtered water distribution system 20 of a network of point-of-use water filtration devices 22 at variations locations on the grounds 12 of the institution 10 is provided by the institution. The filtered water distribution system 20 may be provided to reduce the environmental impact associated with disposable, plastic bottle waste by reducing end user dependence on plastic bottles for consumption of filtered water. The various components of the filtered water distribution system 20 may also be interrelated by a brand to provide an indication to the end users of membership or connection to the particular filtered water solution provided to the institution 10 and then ultimately provided to end users, for example, members of the institution 10.

The filtered water distribution system 20 may be controlled, operated and/or maintained by one or more groups of the institution 10. While the filtered water distribution system 20 may be overseen by any suitable group, such as administrators, students, professors and/or staff, in the embodiment of FIG. 1, the filtered water distribution system 20 is controlled, operated and/or maintained by a student-run enterprise 30 formed of students of the institution 10. The students may oversee day-to-day operations, such as sales, strategic and long term planning, operational expenditures and/or maintenance associated with the filtered water distribution system 20.

A student-run enterprise may be a student organization that is formed by currently enrolled students having a common goal of owning and/or running the enterprise. The student-run enterprise 30 may be recognized by the college or university and may have certain privileges available as part of the recognition such as permission to post flyers on campus, reservation of rooms, use university facilities and advertising space, use of an organization email address and website (including social websites such as Facebook, Twitter, etc.), ability to apply for funding from the university, use of the student organization lists to publicize the organization and its events, use the university logo and trademark, access to campus activities staff and resources, etc. In another embodiment, the student-run enterprise 30 may not be recognized by the institution 10. The college or university may maintain information about the student-run enterprise 30 including officers, email and website addresses, mission/purpose, and faculty advisor. It may be required that the student-run enterprise 30 be in compliance with all federal and state nondiscrimination and equal opportunity laws, orders, and regulations. In some embodiments, scholarships or other awards may be provided to students of the student-run enterprise 30 who meet certain predetermined goals or accomplishments. The student-run enterprise 30 may provide students an opportunity to work with clients (e.g., students, faculty, staff, etc.) and build portfolios in preparation for future careers. In some instances, internships may be provided to students involved in the student-run enterprise 30.

The students involved with the student-run enterprise 30 may interact with clients directly to sell or maintain equipment associated with the filtered water distribution system 20. The students may act as facilitators by directing clients to an e-commerce website from which clients can purchase goods or services associated with the filtered water distribution system 20. Clients may enroll in an automatic refill replenishment program, whereby at regular intervals, replacement filters are sent directly to the client. The e-commerce website may maintain a record of sales of goods or services that are purchased through the website. This record may be reviewed and tracked by the students involved in the student-run enterprise 30. The e-commerce website may record a credit for a sale, and that credit may be associated with one or more of the students who are involved with the student-run enterprise 30. The students involved in the student-run enterprise 30 may receive compensation or other benefits based on the number of credits they accrue. The e-commerce website may be customized to provide information or goods that are of interest to end users of a particular institution 10.

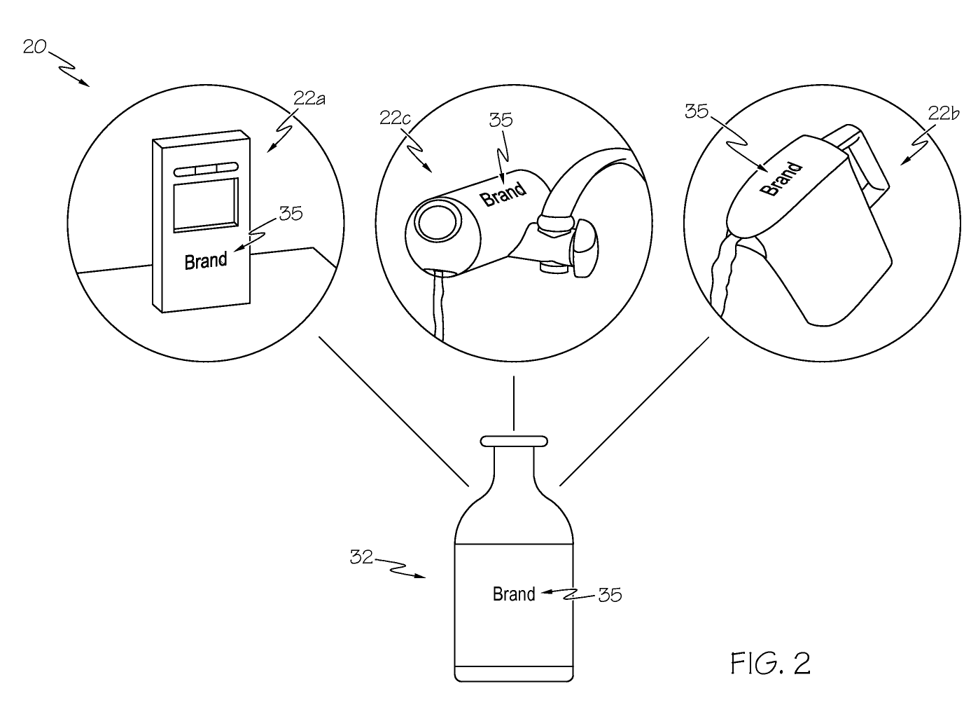

Referring now to FIG. 2, the filtered water distribution system 20 generally includes the point-of-use water filtration devices 22 and portable containers 32 that are used to contain and/or carry filtered water dispensed from the point-of-use water filtration devices 22. Suitable point-of-use water filtration devices 22 include water purification and dispensing systems 22a connected to a water supply, water filter pitchers 22b, faucet mounted filters 22c connected to a faucet, etc. Each point-of-use water filtration device 22 is capable of filtering water (e.g., tap water from a water supply line) at the point where the filtered water is to be dispensed and accessed. The portable containers 32 are used to hold and/or contain the water filtered by the point-of-use filtration devices 22 and may be reusable and formed of any suitable reusable material such as metals including aluminum and stainless steel, and some plastics. It should be noted that while individual point-of-use water filtration devices may be assigned different element numbers they may be collectively referred to herein as element 22.

As can be seen by FIG. 2, each of the point-of-use water filtration devices 22 and the portable container 32 include a brand 35. The brands 35 may all be the same, similar or different from one another. In some embodiments, the brands 35 are used to interrelate the point-of-use filtration devices 22 and the water containers 32 to provide an indication to end users of membership to the particular filtered water solution provided by the institution 10.

II. Point-of-Use Water Filtration Devices

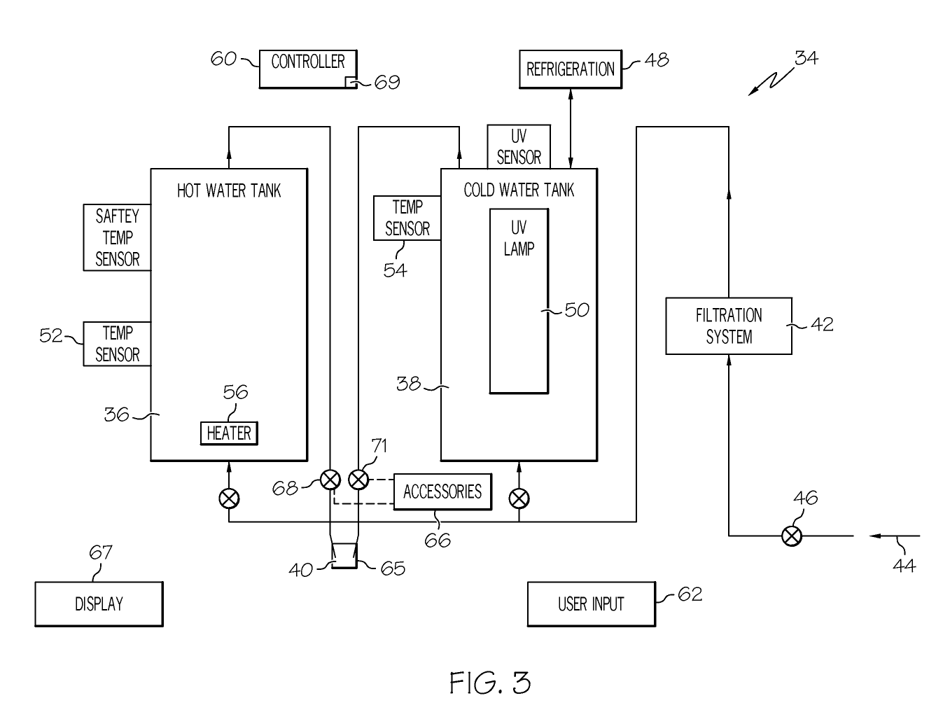

As indicated above, point-of-use water filtration devices are devices that are installed and/or located where the filtered water is to be accessed/dispensed and filter the water at that point. FIG. 3 illustrates an example of a point-of-use water filtration device that is a kiosk-type water purification and dispensing system 34. Such kiosk-type water purification and dispensing systems 34 may be suitable for placement at various locations throughout the grounds 12 of the institution 10, such as within buildings 14 and/or outdoors, such as at commons 16.

The water purification and dispensing system 34 may generally include a hot water tank 36, a cold water tank 38, a dispensing system 40 and a filtration system 42 that is used to filter water supplied to the water purification and dispensing system 34 from a water source represented by arrow 44. The filtration system 42 may be located between a valve 46 and the hot and cold water tanks 36, 38. Any suitable filtration system may be used and may include, for example, carbon filters, anti-calcium filters, micronic filters, etc. Various filters and filtering materials are described in greater detail below. A refrigeration unit 48 may be used to cool water in the cold water tank 38 and a UV lamp 50 may be provided in the cold water tank 38 for sterilization. A heating unit 56 may be mounted in the hot water tank 36 for heating the hot water in the hot water tank 36. Temperature sensors 52 and 54 may be mounted on the hot and cold water tanks 36 and 38 for use in controlling temperature of the hot and cold water in the hot and cold water tanks 36 and 38. The refrigeration unit 48, UV lamp 50, heating unit 56 and temperature sensors 52 and 54 may all comprise any various conventional refrigeration, UV lamp, heating and sensing devices as known to one of ordinary skill in the art.

A controller 60 may be used to control operation of the UV lamp 50, temperature sensors 52 and 54, refrigeration unit 48 and the heating unit 56. The controller 60 may control the refrigeration unit 48 to control the temperature of the water in the cold water tank 38 in response to the cold water temperature sensor 54 and a set temperature, which may be a default temperature or a cold water temperature input via a user input 62. The controller 60 may further control the heating unit 56 to control the temperature of the water in the hot water tank 36 in response to the hot water temperature sensor 52 and a set temperature, which may be a default temperature or a hot water temperature input via user input 62. The controller 60 may comprise any various conventional controllers as known to one of ordinary skill in the art.

In some embodiments, an access control device 66 is provided for allowing and preventing dispensing of filtered water from one or both of the hot and cold water tanks 36 and 38 and thus the kiosk-type water purification and dispensing system 34. The access control device 66, for example, may include valves 68 and 71 that allow or prevent dispensing of the hot and cold water from the hot and cold water tanks 36 and 38. The controller 60 may control the access control device 66, for example, based on an input received from the access control device 66. In some embodiments, the access control device 66 may be controlled based on an input provided by a user. Operation of the access control device 66 will be described in greater detail below.

A metering device 65 may be provided for tracking the amount of filtered water dispensed. The metering device 65 may include a flow sensor that is used to track filtered water flow from the water purification and dispensing system 34. In some embodiments, the metering device 65 may provide flow information to the controller 60, which uses the flow information to determine a total amount of water flow from the water purification and dispensing system 34. In another embodiment, the metering device 65, itself, may include a processor for totalizing flow. A display device 67 may be provided for displaying flow information of the water purification and dispensing system 34, e.g., flow information received from the metering device 65. In some embodiments, the controller 60 and/or the metering device 65 may include a transmitter 69 for transmitting flow information remotely, for example, to a computer or handheld computing device. In some embodiments, flow information may be used in determining remaining filter life.

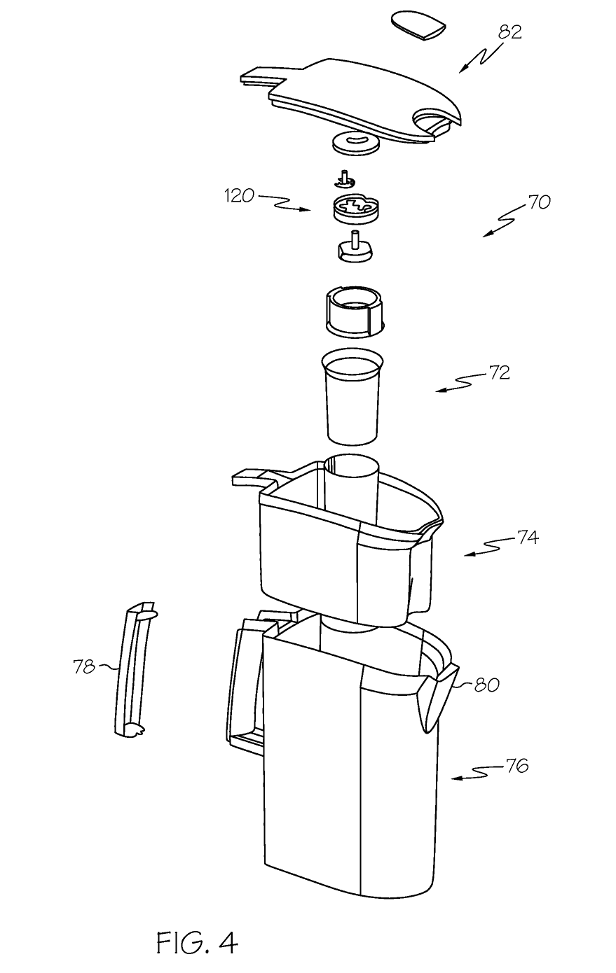

Referring to FIG. 4, another example of a point-of-use water filtration device is a carafe 70 including a filter cartridge assembly 72. Such carafes 70 (e.g., water pitcher) may be suitable for placement at various locations throughout the grounds 12 of the institution 10, such as within buildings 14 at various kitchens, offices, conference rooms, classrooms, etc.

Carafe 70 may include a funnel 74 forming an upper chamber for contaminated water and a pitcher 76 forming a lower chamber for treated water. Pitcher 76 may include a handle 78 and a pour spout 80. When carafe 70 is assembled, funnel 74 may be inserted into pitcher 76 and cover 82 may be placed on top.

An exemplary filter cartridge assembly 72 is shown in FIG. 5. The filter cartridge assembly 72 includes a filter cartridge 84 and cup 86 releasably attached to cartridge 84 by three inwardly facing protrusions 88, spaced at 120 degree intervals, which snap fit into a corresponding detent 90 in cartridge 84. Cartridge 84 is sealed to downwardly extending sealing surface 92 of funnel 74 by an appropriately elastic sealing lip 94 around the perimeter of the upper end of housing 96. Channel 98 of cup 86 is received in recess 100 in filter housing 96. A key 102, which in turn fits into channel 98 of cup 86, is provided for the purpose of properly aligning cup 86 and cartridge 84 relative to funnel 74.

Cup 86 may be constructed and arranged to prevent particles of water treatment media 104 from entering the lower chamber (here, pitcher 76) of the water treatment device. This may be a concern in gravity-fed devices, where loose media particles such as granular activated carbon and ion exchange resins are employed. Contaminated water entering upper inlet end 106 expels media particles 104 from lower outlet end 108 and into bottom 110 of cup 86. The particles are held in bottom 110 of cup 86 as treated water passes upwardly. Treated water flows out of cup 86 through gap 112 between inside wall 114 and outside wall 116, which acts as a deflector-plate to direct the treated water downwardly. Notch 118 assists this flow by reducing the surface tension of the water with the underside of bottom 110 of cup 86. Where the water treatment device is a pitcher 76, gap 112 is preferably located on the same side as handle 78 to keep particles from coming out of cup 86 when pouring.

In this way, cup 86 acts as a tray which prevents media particles from entering pitcher 76. When it is time to replace filter cartridge 84, cup 86 may be removed, rinsed, and reattached to the next filter cartridge. Cup 86 could be constructed in a variety of other ways within the principles of the invention to beneficially reduce the amount of media particles in the treated water.

In some embodiments, the carafe 70 may include a fill counting mechanism 120. In the embodiment of FIG. 4, the fill counting mechanism 120 is a mechanical device that counts the number of times that the carafe 70 is filled. The fill counting mechanism 120 is described in U.S. Pat. No. 6,881,327, the details of which are hereby incorporated by reference as if fully set forth herein. In some embodiments, the carafe 70 may include a flow meter or other device that monitors flow from the carafe 70 and provides flow information to a user (e.g., using a display) and/or to an external computer, for example, for calculating total flow from the carafe 70.

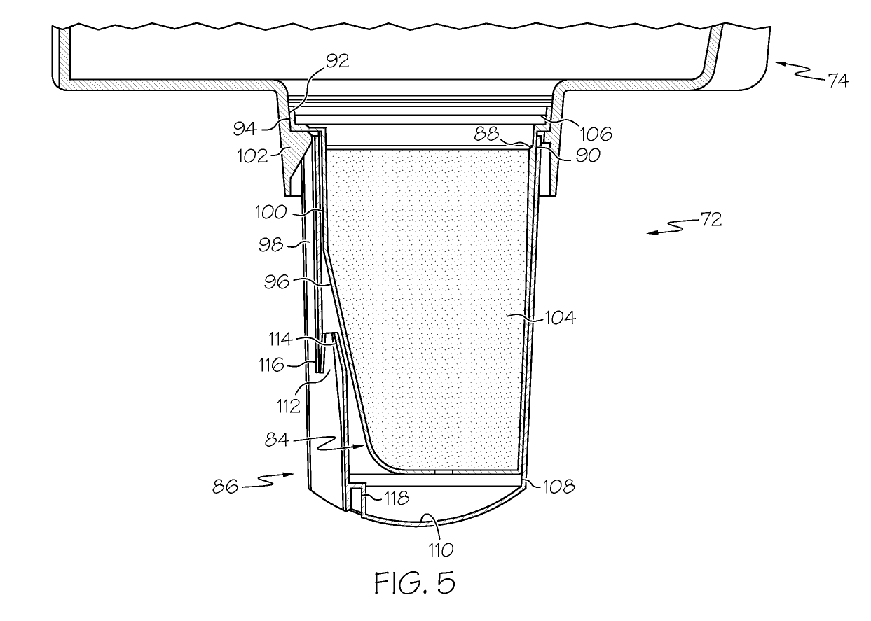

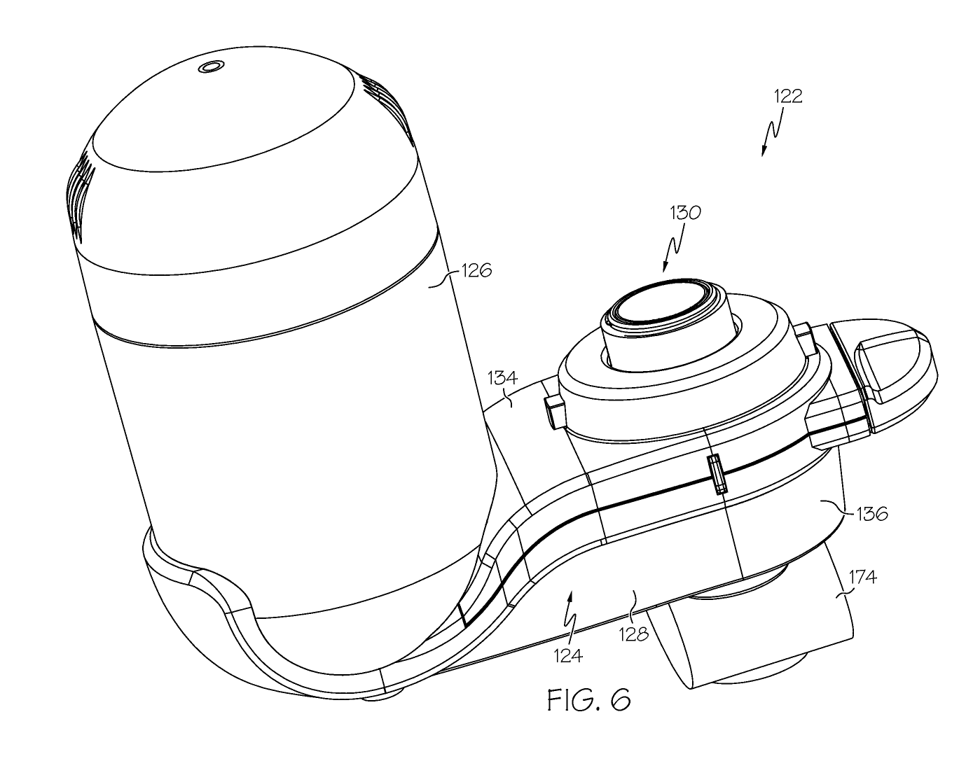

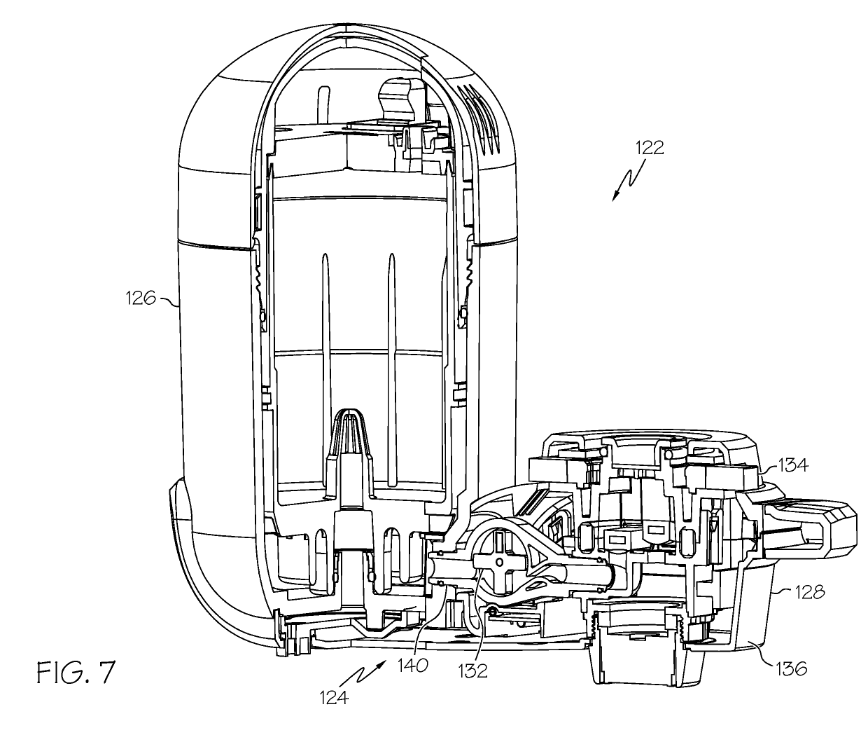

Referring now to FIGS. 6-8, another exemplary point-of-use water filtration device is a faucet-mounted water filtration system 122. Such faucet-mounted water filtration systems 122 may be suitable for placement at various locations throughout the grounds 12 of the institution 10, such as at various kitchen and sink areas within buildings 14. Any number of conventional faucet-mounted filtration systems as known to one of ordinary skill in the art may be used with the systems and methods shown and described herein.

As one example, faucet-mounted filter system 122 may include a faucet-mounted water filter platform 124, a filter housing 126 connected to filter platform 124, and a filter cartridge disposed within filter housing 126. In this exemplary embodiment, filter housing 126 and the filter cartridge are positioned in a vertical orientation. Filter platform 124 may generally include a body 128, a quick connect device 130 and a flow meter 132. The filter system 122 may also include an outer housing comprising an upper housing 134 and a lower housing 136, that partially or completely encompass quick connect device 130 and flow meter 132. In another embodiment, the faucet-mounted filter system may comprise a threaded connection device (e.g., a threaded nut connection) operable to connect to a threaded end of a faucet, rather than the quick connect device 130 shown herein.

Upper and lower housings 134 and 136 may provide an aesthetic outer shell that is quickly and easily connected to and removed from the filter system 122, using connection devices and methods as known to one of ordinary skill in the art, including but not limited to bolt and screw connections, snap fit, welds, latches, etc. As such, upper and lower housings 134 and 136 permit the outer appearance (e.g., color, shape, orientation (vertical filter housing or horizontal filter housing), etc.) of filter system 122 to be simply and efficiently changed without having to change the internal functional components such as quick connect device 130 and flow meter 132. In addition, the upper and lower housings 134 and 136 provide some limited protection to quick connect device 130 and flow meter 132 from the elements such as dirt, debris, etc.

The filter system 122 may be modular in design such that one or more of its components, e.g., filter platform 124, filter housing 126, the filter cartridge, upper housing 134 and lower housing 136, are removably connected to each other, permitting multiple configurations/design changes and or component replacement without having to do a complete re-design of all of its configuration and/or components with every design change. For example, filter platform 124 may be modular such that it enables filter system 122 to have filter housing 126 and thus the filter cartridge in either a vertical orientation or a horizontal orientation.

Referring particularly to FIG. 8, filter platform 124 may also include the flow meter 132 (e.g., flow totalizer) connected to and in fluid communication with a filtered water channel 140. In the embodiment shown, flow meter 132 may include a flow meter housing 142, flow meter inlet 144, a nozzle 146 in fluid communication with flow meter inlet 144, a meter chamber 148 within flow meter housing 142, a flow meter outlet 150 in fluid communication with meter chamber 148, a turbine 152 within meter chamber 148, a signal generator 154 connected to turbine 152, and a signal detector 156.

The turbine 152 may comprise a plurality of turbine blades 158 spaced around the circumference of a hub 160. The turbine 152 may rotate about a rotational axis 162. The hub 160 may also comprise an axle centered thereon and coaxial with rotational axis 162. As shown, the exemplary embodiment comprises four equally spaced blades 158 extending radially from hub 160 and about rotational axis 162. In the embodiment shown, one of the blades 158 comprises a reservoir 164 disposed therein, wherein the signal generator 154 may be positioned within. In addition, turbine 152 may be fabricated from a variety of materials, including but not limited to metals, plastics, composites, and any combination thereof.

The signal generator 154 may comprise a variety of conventional signal generators as known to one of ordinary skill in the art, including but not limited to magnets, RFID tags, colored stripes (for optical detection), and metal blocks. In one embodiment, signal generator 154 comprises a magnet that fits within reservoir 164 of one of the blades 158. The signal detector 156 may be positioned outside of meter housing 142 and electrically connected to a main circuit board 166 as shown in FIG. 8. The signal detector 156 may be positioned adjacent to signal generator 154, but outside of meter housing 142. Other embodiments of signal detectors may include, but not be limited to, proximity switches, RFID reader, and optical transmitter-receiver pairs.

Unfiltered water may water flow into and through flow meter inlet 144 and be directed onto blades 158, causing turbine 152 to rotate. The water travels within meter chamber 148 and then exits flow meter outlet 150. As the signal generator 154 rotates around the meter chamber 148, signal detector 156 detects each time signal generator 154 passes by (i.e., one rotation of the turbine) and sends a signal to a microprocessor 170 mounted on the circuit board 166. In one embodiment, signal generator 154 is a magnet, and signal detector 156 is a reed switch. Every time magnet 154 passes by reed switch 156, the magnetic field of the magnet causes the reed switch to operate. When reed switch 156 operates, it sends a signal to the microprocessor 170.

The microprocessor 170 may be programmed with an algorithm converting the fluid volume equated to each revolution of turbine 152. As such, each operation of the signal detector (i.e., each full rotation of turbine 152), the microprocessor 170 calculates, tracks, and stores the amount (i.e., volume) of water that has passed through flow meter 132 and thus, ultimately through an attached filter cartridge. In some embodiments, the microprocessor 170 may transmit flow information to an external computer or handheld device. Various details of the faucet-mounted water filtration system 122 and flow meter 132 can be found in U.S. patent application Ser. No. 12/205,520, entitled “Apparatus and Methods for Faucet-Mounted Water Filtration Systems,” filed Sep. 5, 2008, the details of which are hereby incorporated by reference in their entirety. The above flow meter is shown for illustration purposes only, and not limitation. It is understood that various other conventional flow metering devices as known to one of ordinary skill in the art may be used with the systems and methods shown and described herein. The flow meter (or a different flow meter) may be used to determine filter life.

Referring back to FIG. 6, the faucet-mounted water filtration system 122 may include an access control device 174 for allowing and preventing dispensing of filtered water from the faucet-mounted water filtration system 122. The access control device 174 may include a valve, for example, for allowing or preventing dispensing of the filtered water. The microprocessor 170 may control the access control device 174, for example, based on an input provided by the access control device 174. In some embodiments, the access control device 174 may be controlled based on an input provided by a user. Additional details of various access control devices will be described in greater detail below.

Filter cartridges used in the above-described point-of-use filtration devices may comprise a variety of commercially available filter cartridges, including but not limited to commercially available filters such as, for example, PUR Plus Filter and PUR Ultimate Filter, which are commercially available from The Procter & Gamble Company, Cincinnati, Ohio. The filter cartridges may comprise carbon block having either axial or radial flow. The filter cartridges may also include an outer wrap such as a sediment wrap made from a variety of materials, including, but not limited to woven and non-woven substrates made of polyolefin fibers, glass fibers, polypropylene, cellulose or combinations thereof. U.S. Pat. No. 6,290,848 discloses a wrapped filter, which is incorporated by reference. Illustrative filter materials and cartridges that may be used may include, but are not limited to, those shown and described in the following co-pending and commonly assigned U.S. patent application Ser. Nos. 11/942,334; 12/209,751; 12/465,159; 12/501,216; 12/702,542 or any combination thereof, which are all herein incorporated by reference. Exemplary filter materials and cartridges that may be used may include those shown and described in the following U.S. Pat. Nos. 4,753,728; 5,019,311; 5,147,722; 5,189,092; 5,249,948; 5,331,037; 5,527,451; 5,536,394; 5,709,794; 5,840,348; 5,882,507; 5,882,517; 6,103,114; 6,057,262; 6,368,504; 6,630,016; 6,827,854; 7,150,829; 7,153,438; 7,186,441; 7,316,323; 7,441,664; 7,614,506; 7,614,507; 7,614,508; 7,615,152; 7,670,479; 7,712,613; 7,740,765; 7,740,766; 7,749,394 or any combination thereof, which are all herein incorporated by reference.

The water filter material may include, but is not limited to, one or a combination of carbon (e.g., activated carbon, including basic mesoporous wood activated carbon, coconut activated carbon, or combinations thereof such as a tube of porous carbon, or a block of porous carbon, or carbon powder or particles sintered with a plastic binder or the like), ion exchange material (e.g., in the form of resin beads, flat filtration membranes, fibrous filtration structures, etc.), zeolite particles or coatings (e.g., silver loaded, cationic polymer coating), polyethylene, or charge-modified melt-blown or micro-fiber glass webs, alumina, diatomaceous earth, etc.

The water filter material may comprise from about 7 grams to about 600 g, from about 15 g to about 300 g, or from about 30 g to about 170 g of activated carbon particles (as described in U.S. application Ser. Nos. 10/464,210, and 10/464,209) to treat low-pressure untreated drinking water. The activated carbon particles may have a bulk density from about 0.2 g/mL to about 0.8 g/mL, from about 0.3 g/mL to about 0.7 g/mL, or from about 0.35 g/mL to about 0.65 g/mL. Activated carbon may be formed into blocks by processes described in U.S. Pat. Nos. 4,664,673; 4,859,386; 5,019,311; 5,189,092; 5,249,948; 5,679,248; 5,679,248; 5,928,588; 5,976,432; and WO 98/43796.

Various flavoring or additive systems may also be provided with the point-of-use filtration systems discussed above. For example, flavors and/or nutrients (e.g., vitamins) may be provided and/or combined with the point-of-use water filtration systems herein such that additives (e.g., flavors and/or nutrients) are dispensable into the filtered water dispensed from the point-of-use water filtration systems. Such cartridges may be any shape, size and/or configuration. One example of such additive cartridges may include disposable additive cartridges as shown and described in the following co-pending and commonly assigned U.S. patent application Ser. Nos. 10/852,708; 11/158,937; 11/159,423 all of which are incorporated by reference herein. Other additives may be introduced to the filtered water such as a gas for carbonating the water.

Water container sterilization devices may also be provided at point-of-use water filtration device locations. For example, a cleaning fluid dispenser or a UV lamp may be provided for use in sterilizing the portable water containers between refills.

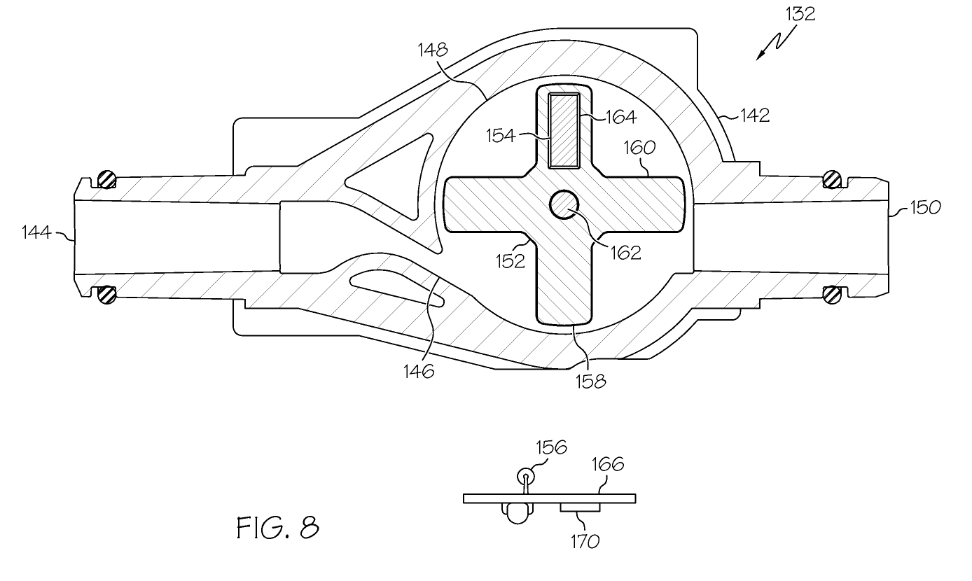

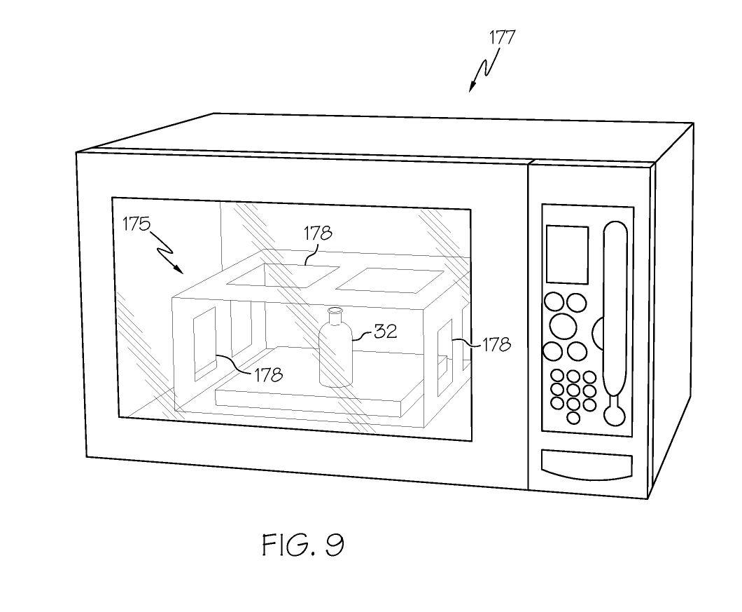

Referring to FIG. 9, one embodiment of a sterilizing unit 175 is located in a chamber 176 of a microwave oven 177. The sterilizing unit 175 may be adapted to emit UV light via UV bulbs 178 in response to microwaves. Sterilization may depend on a number of factors such as the shape of the portable containers 32, the proximity of the UV bulbs 178 to the portable containers, strength of the UV light, type of microorganisms, etc. One or more sterilizing units 175 may be placed near one or more of the point-of-use water filtration devices 22 to allow end user sterilization of the portable containers 32. The above sterilizing unit 175 is shown for illustration purposes only, and not limitation. It is understood that various other conventional sterilizing units may be used with the systems and methods shown and described herein. Additionally, while a single portable container is shown within the sterilizing unit, the sterilizing unit may be sized and configured to sterilize multiple portable containers. For example, a sterilization service may be provided as part of the systems and methods.

In some embodiments, a water quality assurance program may be provided in which filters may be changed on a proper frequency to maintain water quality at the point of use. For example, kiosk-type water purification and dispensing systems 34 may have various filters that may be changed at predetermined intervals. Sediment filters may be replaced about every 2,000 gallons, a reverse osmosis membrane may be flushed about every six months, activated carbon filters may be replaced about every 1,250 gallons and a UV light may be replaced about every 6 months. General servicing of the kiosk-type water purification and dispensing system 34 may occur about every 6 months. Faucet-mount filters may be replaced about every 100 gallons, which depending on usage, may be about every 2-3 months. Filters used in water pitchers or dispensers may be replaced about every 40 gallons, which depending on usage may be about every 1-2 months. Various standards may be used to test water quality, such as NSF/ANSI 58, 42 and 53, all of which are incorporated by reference as if fully set forth herein.

III. Filtered Water Access Control

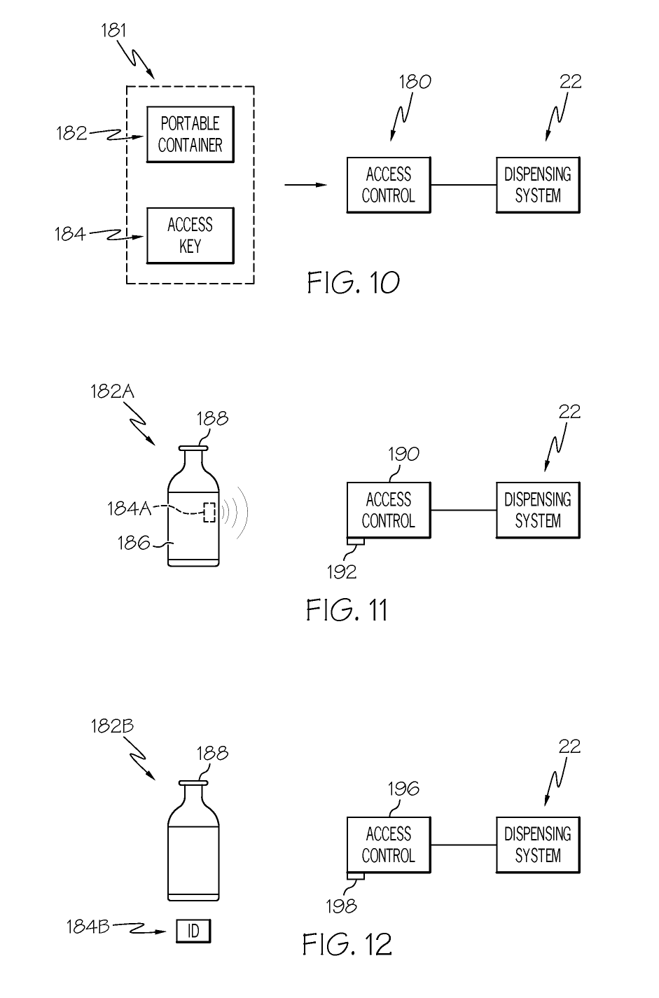

Referring to FIG. 10, an access control system 180 generally allows and prevents access to one or more of the point-of-use water filtration devices 22. A filtered water access and transport system 181 may generally include a reusable, portable container 182 and an access key 184. The term “access key” refers to anything that affords access to one or more of the point-of-use filtration devices 22. In some embodiments, the access key 184 may be part of the portable container 182. In other embodiments, the access key 184 may be separate from the portable container 182. The portable container 182 may be suitable for receiving and holding an amount of filtered water from the point-of-use devices 22 and may be formed of any suitable reusable material such as stainless steel, aluminum and some plastics. A number of illustrative access key embodiments will now be described. The access keys 184 may be suitable for accessing the point-of-use water filtration devices described above including access devices for controlling access to the point-of-use water filtration devices.

Referring to FIG. 11, an embodiment of a portable container 182A includes an access key 184A in the form of a transponder (e.g., an RFID tag). The access key 184A may, for example, be located under a label 186, in a cap 188, within material forming the portable container 182A, etc. The access key 184 can provide a signal that can be read or received by the access device 190 (e.g., using an RFID reader). A processor 192 within the access device 190 may determine whether the signal is valid or invalid. If the signal received is valid, the processor may allow and/or permit dispensing of filtered water from the point-of-use water filtration device 194. If the signal received is invalid, the processor 192 may prevent dispensing of filtered water from the point-of use water filtration device 194.

Referring to FIG. 12, another access key 184B embodiment may be separate from the portable container 182B. In the illustrated embodiment, the access key 184B may be an identification card that may include a magnetic strip. In some embodiments, an access device 196 may include a reader 198 capable of reading the magnetic strip carried by the identification card to determine whether the identification card is valid or invalid. In some embodiments, the access key 184B in the form of the identification card may carry a transponder (e.g., an RFID tag) that can be read or received by access device 196 (e.g., using an RFID reader), in a fashion similar to that described with reference to FIG. 11.

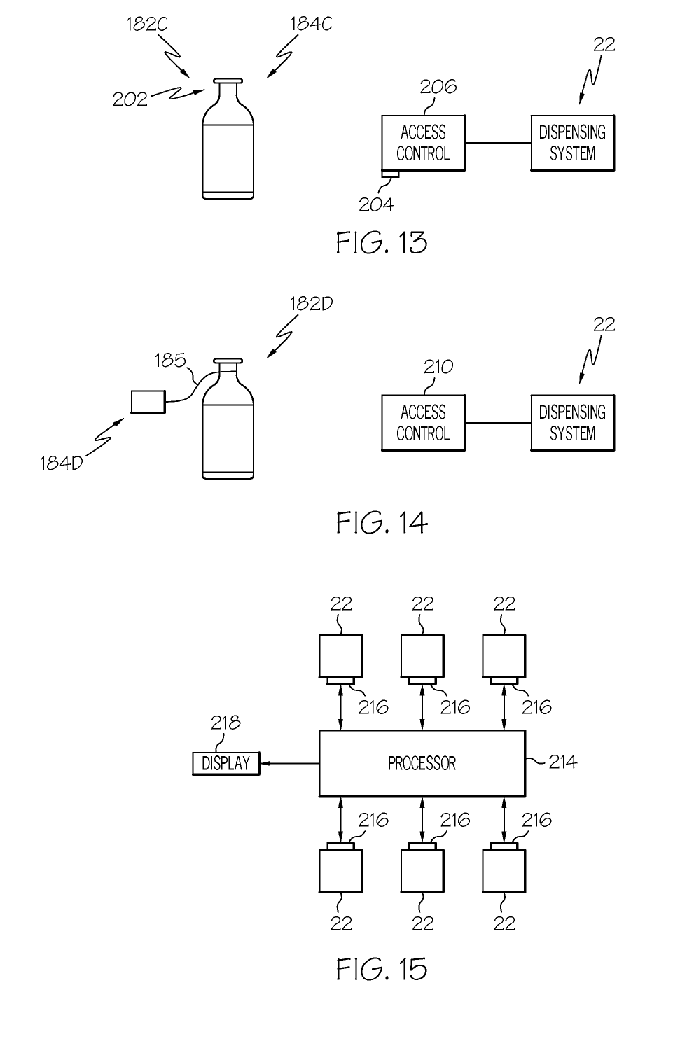

Referring to FIG. 13, the access key 184C may be provided by the shape of the portable container 182C, itself. For example, a head portion 202 (or some other portion) of the portable container 182C may have a shape formed to be received within and/or engage with a receiving mechanism 204 of access device 206. Once properly received by and/or engaged by the receiving mechanism 204, filtered water may be dispensed from point-of-use water filtration device 22. In some embodiments, the portable container 182C is further manipulated (e.g., twisted, rotated, lifted, lowered, etc.) once properly received within and/or engaged by the receiving mechanism 204. Manipulation of the portable container 182C may cause dispensing of filtered water simultaneously with access. In other embodiments, manipulation of the portable container 182C may provide access and a separate dispensing step dispenses the filtered water.

Referring to FIG. 14, an access key 184D may be connected (e.g., removably) to container 182D, for example, by a tether 185 or any other suitable connector. The access key 184D may include a transponder or may have a shape (e.g., keyed shape or configuration) that interacts and/or engages with access device 210 (e.g., corresponding keyed shape or configuration) to provide access to point-of-use water filtration device 22.

Other types of access keys may be incorporated into other device types or objects. For example, hand-held computers and cellular phone devices may include transponders capable of transmitting a signal that is receivable by an access device. The access key, such as an RFID tag, may be incorporated into an article of clothing or other wearable article such as a pin. The access key may be part of a student identification card, an employee identification card, etc. In some embodiments, the access device may include a user input where a user can input an identifier such as a user-created PIN, for example, using a keypad and/or touch screen.

IV. Solutions for Reducing Environmental Impact

Without wishing to be bound by theory, it is believed that providing a network of point-of-use water filtration devices, such as those described above, along with reusable, portable containers to carry and transport the filtered water can significantly reduce the environmental impact of an institution. For example, it is believed that abiotic depletion related to extraction of minerals and fossil fuels, greenhouse emissions, human toxicity levels, terrestrial ecotoxicity levels (impact of toxic substances on terrestrial ecosystems), photo-oxidant formation, acidifcation and/or eutrophication (i.e., nutrification) can be reduced using point-of-use water filtration devices to fill reusable, portable containers compared to the use of single use bottles of water (i.e., disposable bottles of water). It is also believed that such benefits may be shown through comparison of life cycle assessments (LCA) of point-of-use water filtration devices and single-use bottles of water. One standard for making a life cycle assessment is ISO 14040 Environmental management—Life cycle assessment—Principles and framework (2006), and incorporated herein by reference.

The following table records one such LCA that compares kiosk-type water purification and dispensing system 34 with 16.9 oz PET and 5 gallon PET bottles that are customarily used to transport and distribute bottled water. The LCA evaluates the point-of-use filtration device and the bottles according to the following metrics: energy, which is described as the sum parameter of non-renewable energy (e.g., fossil and nuclear) and renewable energy (e.g, biomass, wind, solar) consumed; solid waste, which is described as the sum parameter of solid waste (e.g., municipal, hazardous, nuclear, packaging, etc.) added on a mass basis; global warming, which is described as the sum parameter of emissions contributing to the global warming effect (e.g., CO₂, methane, nitrous oxides, etc.); respiratory effects which is described as the sum parameter of fine dust (inorganics) and volatile organic compounds (organics) that can lead to respiratory effects; non-carcinogenic toxic effects, which is described as effects from air emissions that may lead to non-carcinogenic toxic effects (e.g., emissions from electricity production, including metal emissions into the air); and carcinogenic toxic effects, which is described as effects from air emissions that may lead to carcinogenic toxic effects (e.g., emissions from electricity production, including PAH and dioxins).

| | Kiosk vs. 16.9 oz | Kiosk vs. 5 gallon |
|---|---|---|
| Metric | PET Bottle | PET Bottle |
| Energy | 100X improvement | 20X improvement |
| Solid waste | 100X improvement | 4X improvement |
| Global warming | 100X improvement | 30X improvement |
| Respiratory effects | 100X improvement | 20X improvement |
| Non-carcinogenic toxic effects | 100X improvement | 20X improvement |
| Carcinogenic Toxic effects | 25X improvement | 25X improvement |

Referring now to FIG. 15, it may be desirable to connect the network of point-of-use filtration devices (collectively referred to as element 22) to a processor 214 (e.g., a computer), which may include logic for totaling the amount of filtered water dispensed. In one embodiment, at least some of the point-of-use filtration devices 22 may include metering devices 216, as described above. The metering devices 216 may send or otherwise provide dispensing information to the processor 214 (e.g., wirelessly through IR, Bluetooth, WLAN, other radio frequencies, etc. or a wired connection such as through the Internet, LAN etc.). The processor 214 may use the dispensing information received from the various point-of-use water filtration devices 22 to determine and provide a total amount of filtered water dispensed using the various point-of-use water filtration devices 22 at a particular time. In some embodiments, the processor 214 may maintain a cumulative total of the filtered water dispensed based on the dispensing information. In some instances, an operator of the filtered water distribution system 20 may enter dispensing information, e.g., manually obtained from the metering devices 216 of some of the point-of-use water filtration devices 22 for processing by the processor 214. The dispensing information and the totals may be saved in memory.

In some embodiments, the metering devices 216 may each include a unique identifier that is sent with the dispensing information. This unique identifier may allow the processor to identify and associate dispensing information for a particular point-of-use water filtration device 22. For example, it may be desirable to generate one or more reports that show dispensing trends for any one or multiple ones of the point-of-use water filtration devices 22. Such reports or monitoring may also be accomplished remotely, for example, by connecting the processor to the Internet.

In some embodiments, the processor 214 may include logic and/or algorithms for calculating a number of bottles saved. As one example, the processor 214 may use the dispensing totals to calculate disposable bottle savings. Bottle savings may be calculated using the following equation:

Bottle Savings=Total Volume Dispensed (ounces)/20 (ounces).

The bottle savings may be displayed on a display 218 and/or multiple displays at one or more locations within the grounds of the institution 10 or at other locations outside the grounds of the institution 10. The disposable bottle savings may be calculated for one or more of the point-of-use water filtration devices 22. In some instances, multiple displays 218 may be positioned at various locations throughout the grounds of the institution 10. In some embodiments, the bottle savings may be updated on a regular basis, e.g., every 10 seconds to provide an indication to the users and/or members of a reduction in environmental impact due to implementation of the filtered water distribution system 20. Twenty ounces is used in the equation above as that is a common water bottle size. Other bottle sizes may be chosen, such as 16 ounces, 12 ounces, etc.

In some embodiments, the processor 214 may receive sales data from the e-commerce website relating to replacement cartridges that were purchased by end users of the institution. The processor 214 may assign a volume to each of the replacement cartridges, as discussed above, and may add that volume to the Total Volume Dispensed when calculating bottle savings. For example, bottle savings from water pitcher replacement filters may be calculated using the following equation:

Bottle savings=Number of Filters*40 (gallons)*128 (ounces/gallon)/20 (ounces).

Similarly, bottle savings from faucet-mount filters may be calculated using the following equation:

Bottle savings=Number of Filters*100 (gallons)*128 (ounces/gallon)/20 (ounces).

A water pitcher filter replacement filter may be expected to filter about 40 gallons of water through its useful life. A faucet-mounted replacement filter may be expected to filter about 100 gallons of water through its useful life. These numbers may vary, however, depending on the particular replacement filter design. Through the use of the e-commerce website, the institution 10 or the student-run enterprise 30 may track the number of bottles saved by end users of the institution 10 at locations away from the grounds of the institution 10.

In some embodiments, the processor 214 may include logic and/or algorithms for converting the volume of dispensed water or the bottle savings into a notational representation that communicates the bottle savings to end users of the institution 10. The processor 214 may calculate the volume of the waste eliminated by the filter water distribution system 20, which may be converted into a notational representation, for example, the number of dumpsters of disposable bottles eliminated. The processor 214 may convert the bottle savings into a distance the bottles would cover if stacked end-to-end, which may be converted into a notational representation, for example, the number of times the disposable bottles would circumscribe the Earth. The processor 214 may convert the bottle savings into an area the bottles would cover if laid side-by-side, which may be converted into a notational representation, for example, the number of times an area of the grounds 12 of the institution 10 may be covered. By converting the volume of dispensed water or the bottle savings into such a notational representation, it may reinforce to end users of the institution 10 that the filtered water distribution system 20 reduces waste.

In some embodiments, the processor 214 may include logic and/or algorithms for converting the volume of dispensed water or the bottle savings into a notational representation relating to environmental factors. For example, the processor 214 may calculate the amount of energy saved due to the elimination of production and transportation of the disposable bottles, and convert this amount of energy into an equivalent volume of oil required to produce the amount of energy. The processor 214 may calculate the amount of emissions reduced due to the elimination of plastic processing, and convert this emissions reduction into a corresponding weight of CO₂. Other notational representations relating to environmental factors, for example, emissions related to respiratory effects, non-carcinogenic toxic effects, and carcinogenic toxic effects, are contemplated.

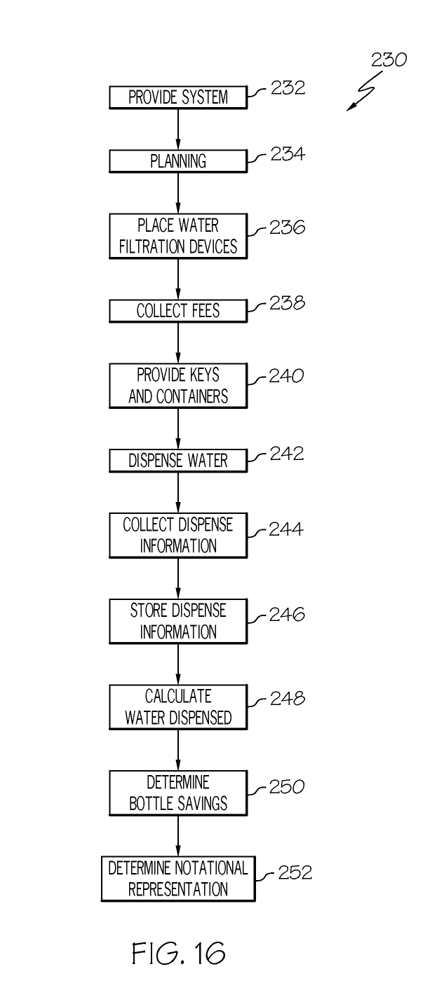

Referring to FIG. 16, a method 230 of reducing environmental impact by providing a filtered water alternative at various locations on grounds of an institution is provided. At step 232, a supplier provides the filtered water distribution system 20 including the point-of-use water filtration devices 22, the portable, reusable water containers 32 and/or any other equipment such as the processor 214 access control devices, access keys, etc. In some embodiments, for example as part of step 232, an assessment is made as to which and how many of the various components of the filtered water distribution system 20 is to be provided to the institution. The size of the filtered water distribution system 20 can be tailored for a particular institution and may depend on numerous factors such as population, geographic size, number of buildings, etc. In some embodiments, it may be desirable to provide at least 1 point-of-use water filtration device for every 500 people of the institution or less, such about 1 point-of-use water filtration device for every 250 people of the institution or less, such as about 1 point-of-use water filtration device for every 100 people of the institution or less. The filtered water distribution system 20 may be provided as a package with one or more of the point-of-use water filtration devices 22 and the portable, reusable water containers 32 being branded to identify membership to the filtered water distribution system 20 and/or solution. For example, the point-of-use water filtration devices 22 and the portable, reusable water containers 32 may be branded with the slogan “Powered by PUR” or any other suitable indicator.

At step 234, an organization of the institution (e.g., a student run enterprise, club, faculty, operation staff, etc.) provides strategic and long term planning for the filtered water distribution system including planning locations for the various point-of-use water filtration devices 22, identifying a cost structure, controlling access to the point-of-use water filtration devices 22, providing feedback to the end users such as water bottle savings, advertising, etc. At step 236 the point-of-use water filtration devices 22 are placed at various locations along the grounds of the institution to be accessed directly by the end users. At step 238, the organization may collect membership fees from the institution and at step 240 the portable, reusable containers 32 and access keys may be provided to the end users free of charge. Alternatively, the organization may collect membership fees directly from the end users of the institution, e.g., students, faculty, staff, administrators, etc. At step 242, the end users may then dispense filtered water from the point-of-use water filtration devices 22 into their portable, reusable containers 32. At step 244, dispensing information may be acquired from the point-of-use water filtration devices 22 and provided to a computer. The computer may collect and store the dispensing information at step 246. At step 248, the computer may total an amount of filtered water dispensed and that total amount may be displayed to the end users. The computer may determine a water bottle savings using the total amount of water dispensed and that water bottle savings may be displayed to the end users at step 250. The computer may also determine a notational representation of water bottle savings using the total amount of water dispensed and display that notational representation to the end users at step 252.

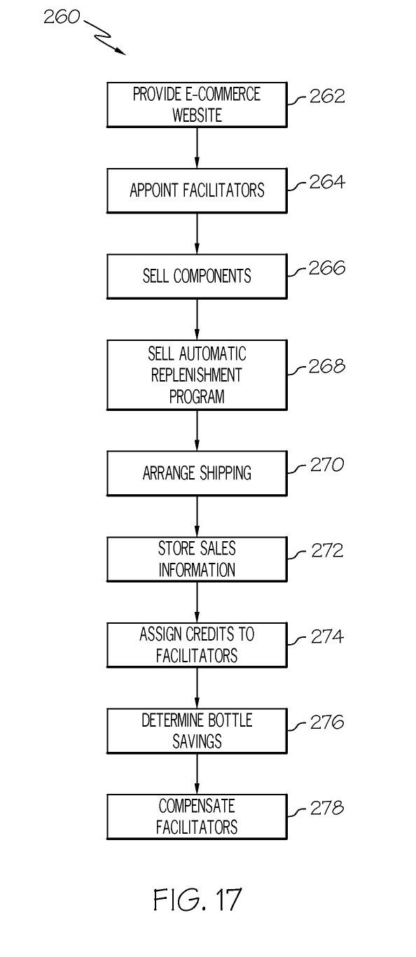

Referring to FIG. 17, a method 160 of reducing environmental impact by providing a branded filtered water system to members of an institution 10 is provided. At step 262, an e-commerce website may be provided where members of the institution may purchase components of a branded filtered water system, including point-of-use water filtration devices 22, portable, reusable water containers 32, and/or any other equipment such as replacement filters for the point-of-use water filtration devices 22. At step 264, facilitators may be appointed. The facilitators may direct members of the institution 10 to visit the e-commerce website to purchase components of the branded filtered water system. At step 266, members of the institution may transact with the e-commerce website such that the e-commerce website sells one or more components of the branded filtered water system to the members. The e-commerce website may also have an option for members of the institution 10 to purchase an automatic replenishment program that arranges for replacement filters for one or more of the components of the branded filtered water system to be sent to the purchasing member on a periodic basis. Replacement filters for the branded filtered water system may be sent to members of the institution after a predetermined amount of time has passed since the previous replacement filter was sent to the member. At step 268, the e-commerce website may sell an automatic replenishment program to members of the institution.

At step 270, the e-commerce website may arrange for transporting, for example shipping, of the purchased components to the member of the institution. At step 272, the e-commerce website may store sales information regarding the item purchased by the member of the institution and the facilitator who directed the member to the e-commerce website. At step 274, the e-commerce website may use the stored sales information to assign credits to the facilitators based on the amount of components that have been purchased by members of the institution. At step 276, the sales information may also be used to estimate the total volume of water that has been delivered to members of the institution, and may be used to calculate a bottle savings and/or a notational representation for bottle savings as described above. At step 278, the facilitators may be compensated based on the amount of credits that each facilitator has been assigned.

V. Experimental Results

Filtered water distribution systems 20 according to one or more of the above-described embodiments were introduced to two institutions 10 to evaluate the performance of the system. Kiosk-type water purification and dispensing systems 34 were configured to measure the amount of water dispensed. The following table records the results from placing multiple kiosk-type water purification and dispensing system 34, referred to as “kiosks” in the table below, within the described grounds 12 of the institution 10.

| | | Institution 2, | Institution 2, |
|---|---|---|---|
| | Institution 1 | Dormitories | Commons |
| Total Kiosks | 5 | 4 | 11 |
| Number of Users (approx.) | 2,000 | 1,200 | 500 |
| Total Volume of Water | 534 | 893 | 1,601 |
| Dispensed (gallons) | | | |
| Duration (months) | 3.2 | 3.2 | 1.3 |
| Average Volume of Water | 165 | 276 | 1264 |
| Dispensed Per Month | | | |
| (gallons/month) | | | |
| Equivalent Number of Bottles | 1,251 | 2,092 | 9,573 |
| Saved Per Month | | | |
| Equivalent Number of Jugs | 107 | 179 | 320 |
| Saved Per Month | | | |

In addition, the filtered water distribution systems 20 introduced to the institutions 10 included water filter pitches 22b, faucet mounted filters 22c, and portable containers 32. Members of the institution were surveyed before the filtered water distribution systems 20 were introduced to the grounds 12 of the institution 10 and 3.2 months after the filtered water distribution systems 20 were introduced to the institution 10. Further, estimates of the volume of water consumed by members of the institution prior to the introduction of the filtered water distribution systems 20 were made based on the quantity of water purchased for the members' consumption prior to the introduction of the filtered water distribution systems 20. The following table records the survey results in regard to members' awareness of the brand 35 used to interrelate the various components of the filtered water distribution systems 20, referred to as “FWDS” in the table, and the volume of water consumed by members of the institution 10 before and 3.2 months after the introduction of the filtered water distribution systems 20.

| | Institution 1 | Institution 2 |
|---|---|---|
| Members' Awareness of the Brand | 74 | 68 |
| Before Introduction of the FWDS | | |
| (%) | | |
| Members' Awareness of the Brand | 94 | 95 |
| 3.2 Months After Introduction of | | |
| the FWDS (%) | | |
| Average Water Consumed Per | 5.94 | 5.56 |
| Institution Member Per Day Before | | |
| Introduction of the FWDS (oz) | | |
| Average Water Consumed Per | 6.11 | 6.06 |
| Institution Member Per Day | | |
| 3.2 Months After Introduction of | | |
| the FWDS (oz) | | |

It should now be understood that a filtered water distribution system of a network of point-of-use water filtration devices may be used to reduce the environmental impact associated with disposable, plastic water bottles. Such a system may be provided on the grounds of an institution, which may allow members of the institution to draw water from the point-of-use water filtration devices into reusable portable containers instead of these disposable plastic water bottles. The filtered water distribution system may be organized and managed by members of the institution. The point-of-use water filtration devices may be branded, which may increase awareness of the brand among users of the point-of-use filtration devices.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of reducing environmental impact by providing filtered water alternatives at various locations within grounds of an institution, the method comprising:
providing a branded filtered water system to members of an institution, the branded filtered water system including a plurality of portable, reusable water containers and a network of point-of-use water filtration devices to be placed at various locations within grounds of the institution; and
interrelating the point-of-use water filtration devices by branding the point-of-use water filtration devices to provide a visual association with the filtered water system.

2. The method of claim 1, further comprising providing access keys to be distributed to members of the institution, the access keys allowing access to the point-of-use water filtration devices in order to dispense filtered water from the point-of-use water filtration devices into the portable, reusable containers.

3. The method of claim 1, wherein the point-of-use water filtration devices comprise kiosks.

4. The method of claim 1, wherein the point-of-use water filtration devices comprise faucet mounted water filtration devices.

5. The method of claim 1, wherein the portable, reusable water containers comprise reusable water bottles.

6. The method of claim 1, wherein the point-of-use water filtration devices comprise portable water filtration devices.

7. The method of claim 6, wherein the portable water filtration devices comprise water filtration pitchers.

8. The method of claim 1, wherein the institution is a school.

9. The method of claim 1, further comprising tracking an amount of filtered water that is dispensed by the system using a metering system.

10. The method of claim 9, further comprising calculating and displaying an amount of plastic water bottles saved by the system provided to members of the institution using the amount of filtered water dispensed.

11. The method of claim 9, further comprising calculating and displaying a notational representation of an amount of plastic water bottles saved by the system provided to members of the institution using the amount of filtered water dispensed.

12. The method of claim 1, further comprising providing replacement filters for the point-of-use water filtration devices to the members of the institution.

13. The method of claim 12, further comprising tracking a number of replacement filters provided to the members of the institution.

14. The method of claim 13, further comprising calculating and displaying an amount of plastic water bottles saved by the system using the number of replacement filters provided to the institution.

15. The method of claim 13, further comprising calculating and displaying a notational representation of an amount of water bottles saved by the system using the number of replacement filters provided to the members of the institution.

16. A method of reducing environmental impact by providing a branded filtered water system to members of an institution, the method comprising:
providing an e-commerce website where members of an institution purchase components of a branded filtered water system;
appointing members of the institution to be facilitators who direct members of the institution to the e-commerce website to purchase components of the branded filtered water system;
selling one or more components of the branded filtered water system to the members of the institution through the e-commerce website;
arranging for the one or more components of the branded filtered water system sold through the e-commerce website to be transported to the member of the institution.

17. The method of claim 16, further comprising:
assigning an amount of credits to the facilitator who directed the member of the institution to purchase the one or more components of the branded filtered water system from the e-commerce website; and
providing compensation to the facilitator based on the amount of credits the facilitator been assigned.

18. The method of claim 16, further comprising:
providing the members of the institution an option to purchase an automatic replenishment program through the e-commerce website, wherein the automatic replenishment program arranges for at least one replacement filter for the one or more components of the branded filtered water system to be shipped to members on a periodic basis;
selling the automatic replenishment program to the members of the institution through the e-commerce website;
arranging for a first replacement filter to be transported to the member who purchased the automatic replenishment program through the e-commerce website; and
arranging for a second replacement filter to be transported to the member who purchased the automatic replenishment program after a predetermined amount of time has passed since the first replacement filter was transported to the member.

19. A method of reducing plastic bottle waste by providing filtered water at various locations within an institution, the method comprising:
providing a branded filtered water system to members of an institution, the branded filtered water system including a plurality of point-of-use water filtration devices to be placed at various locations within the institution, wherein the point-of-use water filtration devices each include a source indicator identifying membership to the branded filtered water system;
providing a metering system configured to track an amount of filtered water dispensed by at least one of the point-of-use water filtration devices; and
determining plastic bottle savings using information from the metering system.

20. The method of claim 19, further comprising displaying the plastic bottle savings, wherein the plastic bottle savings is a function of dispensed filtered water determined using the metering system.
